(19) United States
(12) Patent Application Publication
(10) Pub. No.: US 2006/0267570 A1
(43) Pub. Date: Nov. 30, 2006

(54) Apparatus and method for testing bio-semiconductor integrated circuits

(76) Inventor: Brian J. Arkin, Pleasanton, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/139,455

(22) Filed: May 26, 2005

(51) Int. Cl. G01N 27/00

(52) U.S. Cl. 324/71.4

(57) ABSTRACT

A bio-semiconductor integrated circuit including at least one sensor that generates an electrical signal in the presence of a material. The signal is processed in detection circuitry. A sensor simulator is in communication with the detection circuitry and/or sensor. Using the sensor simulator, test signals may be transmitted to the detection circuitry and/or sensor for testing of the bio-semiconductor integrated circuit.

### FIELD OF THE INVENTION

Aspects of the present invention relate generally to the field of integrated circuit testing, and particularly to an apparatus and method for testing bio-semiconductor type integrated circuits.

### BACKGROUND

A newly-designed integrated circuit (“IC”) is typically fabricated over a process of several weeks, involving preparation of silicon substrate wafers, generation of masks, doping of the silicon substrate, deposition of metal layers, and so on. The IC typically has various individual electronic components, such as resistors, capacitors, diodes, and transistors. The metal layers, which may be aluminum, copper, or other conductive material, provide the interconnection mesh between the various individual electronic components to form integrated electrical circuits. Vias formed of electrically conductive material often provide communication pathways between various metal layers. Contacts provide communication links between points in the metal layer and individual electronic components.

Unfortunately, newly fabricated ICs of any complexity rarely work as expected. Normally, defects in the operation of the IC are discovered during testing. Also, some functions of the IC may operate properly under limited conditions, but fail when operated across a full range of temperature and voltage at which the IC is expected to perform. Once the IC has been tested, the designer may change the design, initiate the manufacture of a second prototype IC via the lengthy process described above, and then test the new IC once again. However, no guarantee exists that the design changes will correct the problems previously encountered, or that all of the problems in the previous version of the IC have been discovered.

In recent years, chemical and biological detection, identification and other processes, once the sole domain of the laboratory, are being integrated into semiconductor IC technologies. Such ICs are sometimes referred to as a “bio-chip” or a “lab-on-a-chip.” One example of such a bio-chip is an IC that includes an array of DNA sensors. The DNA sensors are arranged to generate a current output when a target DNA strand binds to a matching probe DNA strand applied to the sensor. Another example, is an IC deploying an array of capacitive sensors. Each capacitive sensor alters its dielectric constant in the presence of a fluid having a target particle. Alteration of the dielectric constant causes variation in an output voltage from the sensor.

One drawback of such bio-chips or bio-semiconductor integrated circuits, involves a lack of an integrated manner by which the functionality of the circuits may be tested and/or calibrated. Typically, a bio-semiconductor chip is not reusable, meaning that once the chip is exposed to bio-materials, it may not be used again. The single use nature of bio-chips makes testing problematic. Non bio-semiconductor type integrated circuits are oftentimes tested by applying a known sequence to the inputs of the chip and comparing the output of the chip with the output expected by the known input sequence. Such a testing scheme does not impact the future functionality of the chip. In contrast, due to the one use nature of bio-semiconductor chips, conventional testing methods can be problematic in that the input sequence, the biological material, may only be applied to the chip once. As such, testing the chips with biological material, while producing a test output, destroys future non-testing use of the chip. Against this back-drop aspects of present invention were developed.

### SUMMARY

One aspect of the present invention involves a bio-semiconductor integrated circuit comprising at least one sensor adapted to generate an output signal in the presence of a material. Detection circuitry is coupled with the at least one sensor. The detection circuitry is configured to detect a signal from the at least one sensor, where the signal is generated as a function of the presence of the material. For testing, a controllable signal source, arranged to generate a test signal output, is coupled with the detection circuitry. The test signal output simulates the sensor output signal.

Another aspect of the present invention involves a bio-semiconductor system comprising a sensor site. The sensor site includes at least one sensor adapted to generate an output signal in the presence of a material. The sensor site further includes detection circuitry coupled with the at least one sensor, the detection circuitry detecting a signal from the at least one sensor, the signal being a function of the presence of the material. For testing of the bio-semiconductor, a controllable signal source having a test signal output is in communication with the sensor site. Some or all aspects of the system may integrated in a semiconductor. Further, some or all aspects of the system may be separately deployed.

Another aspect of the present invention involves a method for testing a bio-semiconductor integrated circuit. The bio-semiconductor integrated circuit includes at least one sensor site adapted to generate an output signal in the presence of a material. The method includes sending a testing control signal to the bio-semiconductor integrated circuit. The testing control signal is adapted to generate a signal simulating the output signal of the at least one sensor site. The method further includes detecting a test output generated as a function of the testing control signal. Finally, the method includes comparing the test output with an expected output.

Another aspect of the present invention involves a method for testing a bio-semiconductor integrated circuit. Again, the bio-semiconductor integrated circuit includes at least one sensor site adapted to generate an output signal in the presence of a material. The method includes receiving a testing control signal at the bio-semiconductor integrated circuit. As a function of the testing control signal, the method further includes generating a test signal simulating the output signal of the at least one sensor site.

Other embodiments and advantages of the present invention will become apparent after reading the following detailed description and associated drawings.

### BRIEF DESCRIPTION OF THE DRAWINGS

FIG. 1 is a block diagram illustrating one arrangement of a bio-semiconductor integrated circuit including a testing configuration, in accordance with aspects of the present invention;

FIG. 2 is a flowchart illustrating one particular method for testing a bio-semiconductor integrated circuit, in accordance with aspects of the present invention;

FIG. 3 is a block diagram illustrating one particular arrangement of a bio-semiconductor integrated circuit including an internal testing configuration, in accordance with aspects of the present invention;

FIG. 4 is a schematic diagram of a DNA sensor and detection circuitry;

FIG. 5 is a section view taken along line 5-5 of FIG. 4 and further illustrating the binding of a target DNA strand to a probe DNA strand immobilized on the DNA sensor;

FIG. 6 is a block diagram illustrating one particular arrangement of a bio-semiconductor integrated circuit including an internal testing configuration, in accordance with aspects of the present invention;

FIG. 7 is a schematic diagram illustrating a capacitive sensor;

FIG. 8 is a block diagram illustrating a silicon nanowire type bio-semiconductor integrated circuit including an internal testing configuration, in accordance with aspects of the present invention; and

FIG. 9 is a block diagram illustrating a second silicon nanowire type bio-semiconductor integrated circuit including an internal testing configuration, in accordance with aspects of the present invention.

### DETAILED DESCRIPTION OF EMBODIMENTS OF THE INVENTION

Aspects of the present invention involve an apparatus and method for testing bio-semiconductor integrated circuits. As used herein the term “bio-semiconductor” integrated circuit refers to any type of semiconductor integrated circuit including one or more integrated sensors or configured to receive a signal from one or more external sensors, the sensor adapted to detect the presence of a target, whether it is a biological, chemical, or biochemical material (“material”), such as a compound, particle, an oligonucleotide, e.g. DNA, RNA, PNA, protein, e.g., antibody lectin, etc., microorganism, e.g., viral or bacterial, etc., through the generation or alteration of a recognizable electrical signal, such as a voltage change, dielectric change, current change, conductance change, or resistance change, in the presence of such materials. As used herein, the term “semiconductor structure” refers to any active or passive circuit structure formed from appropriate doping of a semiconductor base material, such as silicon, silicon germanium, germanium, and gallium arsenide. Some examples of semiconductor structures include transistors and diodes formed in a complementary metal oxide semiconductor (“CMOS”) and/or bipolar arrangements with appropriate diffusions. As will be discussed in greater detail below, embodiments of the invention include a controllable signal source arranged to simulate sensor output in the presence of a material. Such a bio-semiconductor having a controllable signal source allows for bio-semiconductor chip testing without exposing the chip to the material.

Bio-semiconductor integrated circuits typically include at least one sensor that generates a recognizable electrical signal in the presence of a material. It is also possible for the sensor to be remote from the integrated circuit. Sensor technologies compatible with the present invention include “redox cycling” or other like electrochemical sensors and CMOS capacitive sensors. With regard to “redox cycling sensors”, a single-stranded nucleic acid probe is spotted and immobilized on a surface, typically gold or other like metal, the probe is often specific for a single-stranded nucleic acid molecule(s) in a sample, i.e, target. Hybridization between probe and target occurs when each is present in quantities necessary for detection sensitivity. A suitable chemical substrate and electrochemically redox active compounds are created by an enzyme label bound to the target nucleic acid strands. When the target binds to a specific probe simultaneous oxidation and reduction leads to current flow into the IC. Note that other probe target combinations, such as antibody, virus, lectin, protein, etc., also are used in these sensors. In each case a specific probe site can be located for a labeled target.

Another compatible sensor is a CMOS capacitive sensor based on chip technology for detection of overlying material, i.e., target analytes, using a “DEP”-cage approach. The capacitive sensor is based on the natural motions of particles in response to spatially non-uniform electric fields. Any number of particles may be detected and manipulated using this technology, for example, cells, proteins, nucleic acids, etc. For example, a sample of blood may be tested for the presence of bacteria due to the unique motion of the bacteria in response to the non-uniform electric field.

In each of the two cases described above, “redox cycling” and “capacitive,” an electric signal is generated by the sensors in the presence of a target biologic or chemical based analyte.

Note that for purposes of the present invention “Hybridization” refers to the pairing of complementary polynucleotides during an annealing period. The strength of hybridization between two polynucleotide molecules is impacted by the homology between the two molecules, stringency of the conditions involved, the melting temperature of the formed hybrid and the G:C ratio within the polynucleotides. Thus, a “redox cycling” sensor would use nucleic and probe and target having an appropriate hybridization strength for detection by the IC.

Further, for purposes of the present invention “Polynucleotide,” “oligonucleotide” or grammatical equivalents thereof refer to a linear sequence of at least two nucleotides covalently linked together. As will be appreciated by those of skill in the art, various modifications of the sugar-phosphate backbone may be done to increase the stability of such molecules, including chemical modifications such as phosphorothioate, methyl phosphonate, and the like. The nucleotides may be ribonucleotides or deoxyribonucleotides, or a mixture of both. Further, such molecules may be functionalized by coupling with one or more molecules having distinct characteristic properties for purposes of facilitating the addition of labels. Examples of polynucleotides in the context of the present invention include single and double stranded DNA, single and double stranded RNA, and hybrid molecules having mixtures of single and double stranded DNA and RNA. These molecules are often useful as probe and target in various sensor technologies useful with aspects of the present invention.

Also, note that for purposes of the present invention the term “antibody” is used in the broadest sense and specifically covers monoclonal antibodies, polyclonal antibodies, multispecific antibodies, e.g., bispecific antibodies, chimeric antibodies, humanized antibodies, fully synthetic antibodies and antibody fragments so long as they exhibit the desired biologic activity, i.e., binding specificity.

It is also possible to chemically add a charge marker to a target material. An appropriately configured bio-chip includes one or more sensors adapted to detect/attract the charge marker added to the target material. When the charge marker material binds to the sensor, the sensor produces and electrical signal identifying the presence of the target material.

A bio-semiconductor integrated circuit further includes detection circuitry adapted to detect the electrical change from the sensor caused by the presence of the material. One aspect of the invention involves a bio-semiconductor integrated circuit having one or more controllable electrical or signal sources, such as a controllable voltage source, current source, resistance, etc., adapted to provide a known electrical signal, such as a known voltage, current, resistance, or range thereof, to the detection circuitry in order to ensure that such circuits properly detect the electrical signal or change therein caused by the presence of the material

One embodiment of the invention involves a bio-semiconductor integrated circuit structure formed with one or more redox cycling type sensors adapted to generate a current in response to the presence of a material, such as an oligonucleotide molecule. The semiconductor structure further includes a detection circuit adapted to detect the current and generate an output as a function of the detected current. For testing, a controllable current source is coupled with the detection circuit to provide a known current or range of currents in order to test and/or calibrate the detection circuit.

Another embodiment of the invention involves the CMOS based bio-semiconductor integrated structure formed with at least one capacitive sensor arranged so that its dielectric constant is altered in response to the presence of a material, such as a particle. The alteration of dielectric constant causes a change in voltage output from the sensor. The bio-semiconductor structure further includes a detection circuit adapted to detect the voltage change and generate an output as a function of the detected voltage. For testing, a controllable voltage source is coupled with the detection circuit to provide a known voltage or range of voltages to the circuit in order to test and/or calibrate the detection circuit.

Another embodiment of the invention involves a bio-semiconductor structure formed with one or more silicon nanowire sensors arranged so that the conductivity of the nanowire is altered in the presence of a material, such as a virus where the virus is captured by an antibody immobilized to the nanowire. In the presence of a constant current, the alteration of conductivity of the nanowire causes an output voltage change from the nanowire in the presence of a material. The bio-semiconductor further includes a detection circuit arranged to detect the conductance change. For testing, a controllable current source may be coupled with the nanowire to induce a known current or range of currents through the nanowire in order to test and/or calibrate the nanowire, as well as the detection circuitry. Further, a variable resistance source may be coupled with the nanowire to simulate the binding and dissociation of targets to the probes on the nanowire.

In the various embodiments discussed herein, the sensors may be formed in or coupled with the outer surface of the semiconductor structure to form a bio-semiconductor structure. The sensors are arranged so that a material may contact the sensor or otherwise be placed in the presence of the sensor e.g., a target single stranded DNA from a chemical sample. It is possible for the sensor to be physically separate from the semiconductor, and to provide an output signal to the semiconductor as a function of the presence of a material. Further, the testing/calibration elements may be integrated within the semiconductor.

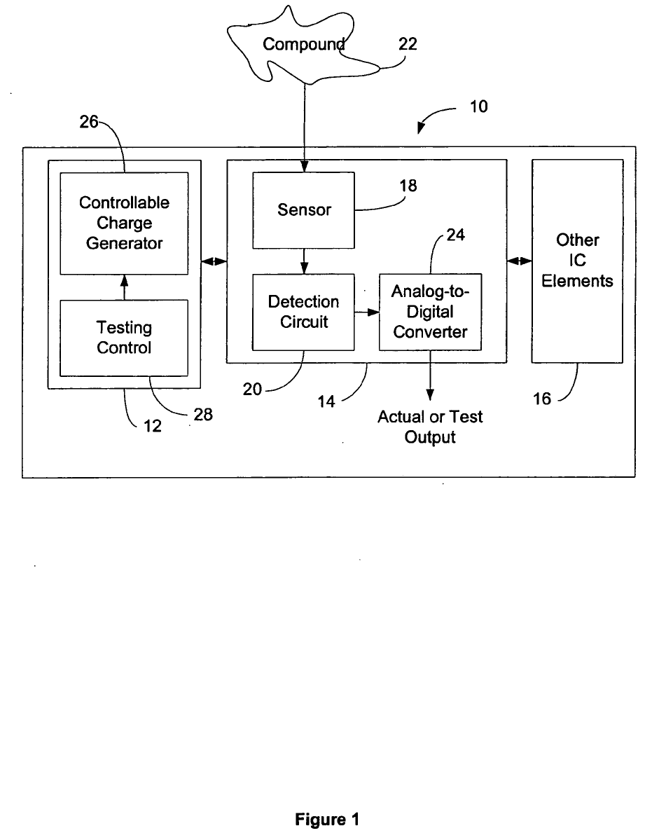

FIG. 1 is a block diagram illustrating the overall architectural structure of a bio-semiconductor 10 conforming to aspects of the present invention. The bio-semiconductor includes a testing signal or “charge” generator 12 coupled with a sensor site 14. The bio-semiconductor may further include other conventional integrated circuit components 16, such as memory, communication pathways, a central processor, other processors, etc. The sensor site 14 includes a sensor 18 that is coupled with detection circuitry 20. As mentioned above, the sensor provides some type of recognizable electrical signal in the presence of a target material 22. The detection circuitry receives the sensor's electrical signal and generates an output as a function of the detected signal. In one implementation, the output is fed into an analog-to-digital converter 24 that converts an analog output from the detection circuitry into a digital representation of the output. When running a test or calibrating a sensor site, the output from the detection circuitry is a function of the test input to the detection circuitry rather than being a function of the sensor output during normal (i.e., non-testing) operation.

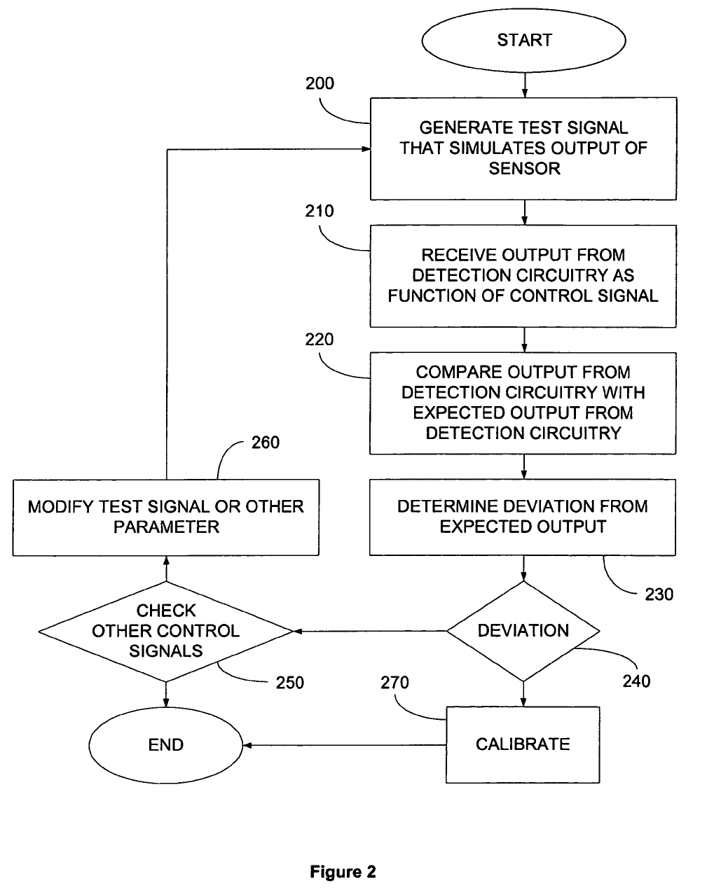

FIG. 2 is a flowchart illustrating one method for testing and/or calibrating a bio-semiconductor chip, conforming to aspects of the present invention. Referring to FIGS. 1 and 2, As mentioned above, various implementations of the present invention may include a controllable signal source 12 that generates a test charge (current or voltage, for example) signal that simulates the output of a sensor in the presence of a target material. The signal source may be integrated within the bio-semiconductor integrated circuit, or may be external to the bio-semiconductor with an appropriate input and signal pathway for communicating the test signal to the appropriate test location. The controllable signal source may include a controllable charge generator 26 configured to receive a testing control signal 28.

For testing/calibration, the first operation involves generating a test signal that simulates a test material in the presence of the sensor (operation 200). Next, the detection circuitry 20 generates a test output as a function of the test signal input (operation 210). The test output may be analog or digital. In one example discussed with respect to FIG. 1, the detection circuitry outputs an analog signal as a function of the actual sensor signal or simulation signal, and the analog signal is converted to a digital signal from the A-to-D converter 24. The bio-semiconductor may provide a communication pathway directly from both the analog and digital outputs to test each output signal. The output from the detection circuitry and/or the A-to-D converter is compared with an expected output (operation 220). The comparison may generate an output of the deviation between the actual output and the expected output (operation 230).

To generate the sensor simulation, the appropriate testing control signal is transmitted to the controllable charge generator. In response, the controllable charge generator generates an appropriate sensor output simulation signal. Comprehensive testing of a bio-semiconductor chip may be performed on an automated test equipment (“ATE”) platform. With an ATE it is possible to generate the appropriate testing control signals as well as monitor the detection circuitry output, and compare the output with the expected output.

If there is no deviation from the expected output or the deviation is within an allowable range of deviation (operation 240), then the detection circuitry 20 is working properly (or within specifications) and other signals or conditions may be tested (operation 250/260). The detection circuitry should work correctly under a range of conditions; thus, it is possible to modify the test signal to test the full range of possible sensor signals and/or modify other parameters, such as clock speed, temperature, etc., to test the functionality under a full range of possible conditions (operation 260).

If, on the other hand, the detection circuitry 20 produces an outcome that deviates from the expected outcome, the detection circuitry may be calibrated to account for the deviation (operation 270). Accurate calibration may be performed after various modified control signals (operation 260) are passed to the detection circuitry so that the performance of the detection circuitry is tested over a range of conditions. In some cases, the output of the detection circuitry may completely fail, be unpredictably out of an expected range, or otherwise perform in such a manner that its output is erroneous to such an extent that the sensor location is disqualified or the entire chip is disqualified. Because some chips employ sensors in a matrix of many sensors, it is possible to have some sensor locations 18 that function properly (without calibration), some sensor locations that require calibration, and some sensor locations disqualified.

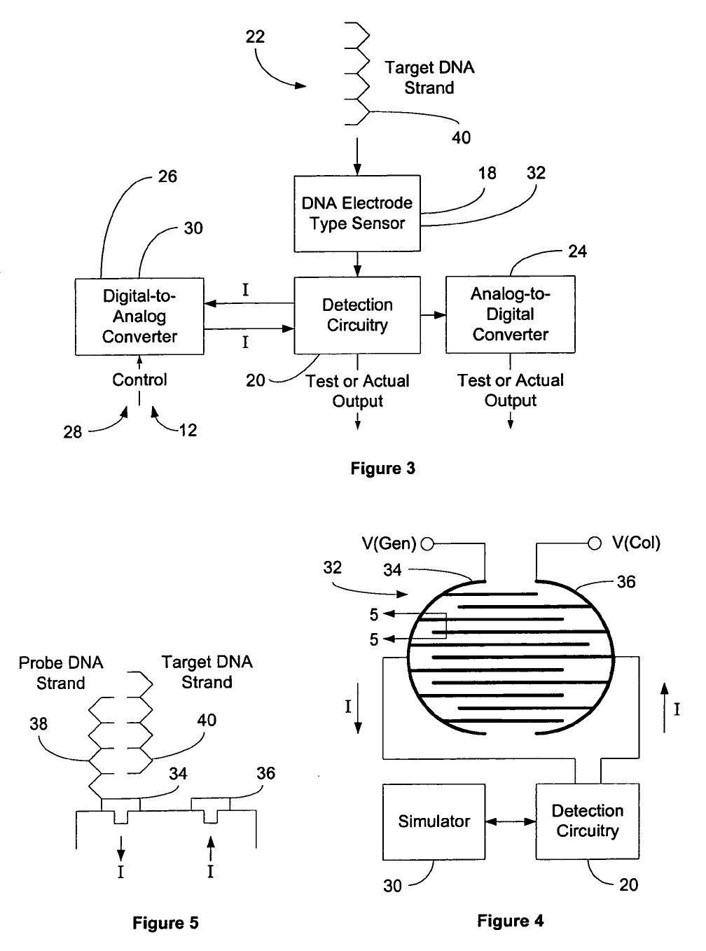

FIG. 3 is a block diagram illustrating one particular sensor site 14 implementation conforming to aspects of the present invention. The sensor site is deployed in a bio-semiconductor integrated circuit able to detect DNA molecules, with the integrated circuit including a controllable charge generator 26 in the form of controllable current source 30 for testing the detection circuitry 20. FIG. 4 is a schematic diagram of one particular implementation of a DNA sensor 32, and FIG. 5 is a section view taken along line 5-5 of FIG. 4. The DNA sensor includes interdigitated generator and collector electrodes (34, 36) formed on an underlying semiconductor structure. A constant voltage is applied to the generator and collector electrodes. The electrode arrangement may be referred to as a DNA sensor or “redox cycling” sensor herein.

As noted above with regard to redox cycling sensors, single stranded probe molecules 38 for one or more known sequences of DNA are applied to the electrodes (34, 36). Enzyme label molecules are bound to the probe sequences to form a sort of electrical marker. An analyte containing a target molecule 40 with an unknown DNA sequence is applied to the probe sequences, and hybridization of the target and probe molecules occurs between matching DNA sequences. Hybridization, as discussed above, is basically a form of chemical binding, such that matching target and probe sequences bind together. Electrodes with hybridized target and probe molecules cause oxidation and reduction potentials at the electrodes resulting in a current flow (I) from the generator electrodes and to the collector electrodes of the DNA sensor. By knowing the probe sequence, it is possible to identify the target molecules by which probe sequence the target molecules bind. The result of the binding is a current flow from the particular DNA sensor where the match occurs. As discussed further below, because the sensor outputs a current signal, a controllable current source is used to generate the appropriate sensor simulation.

A particular DNA array chip may be used to identify countless DNA sequences by applying a desired probe DNA sequence to the electrodes. Different DNA sequences, however, have variable ranges of output current depending on the oxidation and reduction potential from matched sequences. Some DNA array sensors have a range of output currents between 10⁻¹² A to 10⁻⁷ A. Examples of DNA array chip arrangements are described in “Sensor Arrays for Fully-Electronic DNA Detection on CMOS” to R. Thewes et al, IEEE International Solid-State Conference 2002, and “A Fully Electronic DNA Sensor with 128 Positions and In-Pixel A/D Conversion” to R. Thewes et al, IEEE International Solid-State Conference 2004, both of which are hereby incorporated by reference herein.

Detection circuitry 20 is coupled with the output of the sensor 32 to detect and measure the output current from the sensor. In one example, the detection circuitry has an analog output, which is sent to the analog-to-digital converter 24 that converts the analog signal to a digital signal. The digital representation of the sensor current may then be sent to other portions of the integrated circuit for further processing.

For testing and/or calibration, the current source 30 is coupled with an input of the detection circuitry 20. In one particular implementation, the current source is integrated within the bio-semiconductor integrated circuit; thus, it does not require a separate current source or an external connection. Such an arrangement may be conveniently tested using an ATE configured to provide the appropriate control signal 28 to the current source. The current source 30 may be controllable so as to precisely output a range of currents, or may be simply and on/off current source with a set output. In either case, the current source provides a known current, or range of currents, to the detection circuitry to simulate the output of the redox cycling type sensor. With a known input current, the functionality of the detection circuitry 20 may be determined and/or calibrated, without applying an actual material sample 40 to the sensor. In the example of FIG. 3, the current source is provided with a digital-to-analog converter that converts a digital control signal 28 to a test current that simulates the DNA sensor output.

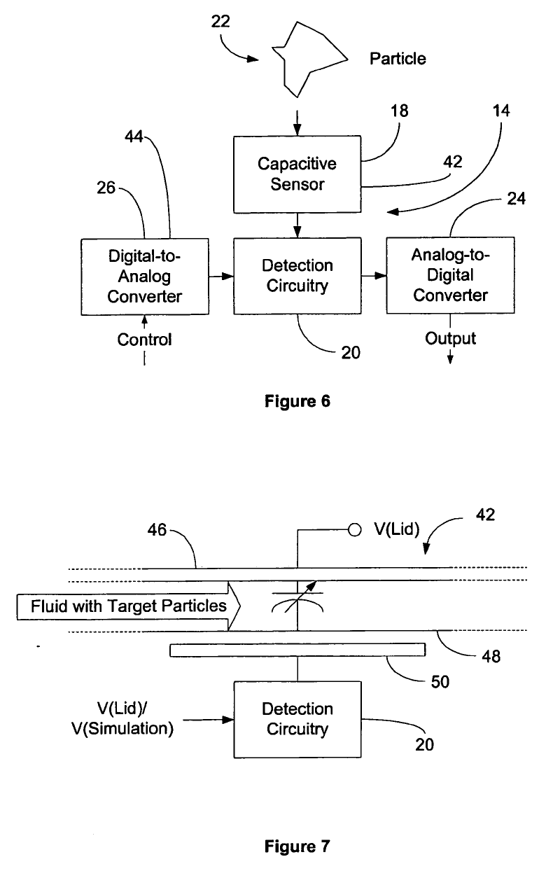

FIG. 6 is a block diagram illustrating another particular sensor site testing implementation conforming to aspects of the present invention. The sensor site 14 illustrated in FIG. 6 involves a CMOS capacitive type sensor 42, discussed above, able to detect overlying material, such as a particle. The output of the sensor is coupled with detection circuitry 20. The sensor site produces a voltage change at its outputs based on a dielectric constant change produced in the presence of a particle. For testing and/or calibration, the integrated circuit includes a controllable voltage source 44, which simulates the capacitor voltage changes, for testing/calibrating the detection circuitry and sensor site.

FIG. 7 is a schematic diagram of the capacitive sensor arrangement. The particle sensor includes a glass lid 46 arranged over an underlying semiconductor surface 48. An electrode 50 is exposed at the chip surface. Fluid containing particles may be injected into the region of a particle sensor, between the glass 46 and electrodes 50. The presence of the fluid and particles affects the coupling capacitance between the lid and the electrodes. To detect a capacitance change, voltage at the lid and the electrode are measured. A capacitance change is recognized through voltage variations at the lid, the electrode, or both. A plurality of such capacitive sensors may be deployed in an integrated circuit. In such a deployment, each sensor or “microsite” may be individually addressable and may be individually used to detect a particular particle. One such capacitive sensor arrangement is described in “Capacitive Sensor Array for Localization of Bioparticles in CMOS Lab-on-a-Chip,” Romani et al, IEEE International Solid-State Conference 2004, which is hereby incorporated by reference herein.

The capacitive sensor 42 is coupled with detection circuitry 20 that detects voltage variations at the lid and electrode, and processes the voltage variations to produce a signal representative of the capacitive change or dielectric change in the sensor due to the presence of fluid and particle types. To test/calibrate the detection circuitry, without introduction of fluid and particles, the controllable voltage source 44 in the form of a digital-to-analog converter is arranged to provide a known voltage, or range of voltages, to the detection circuitry, which is configured to simulate the voltage change induced by a capacitance change in the sensor. A known signal may be provided to the detection circuitry, and the detection circuitry produces a known output commensurate with the known input. Any deviation from the known output can be used to calibrate the detection circuitry, or if the deviation is significant, used to indicate that the chip or a particular microsite is not functioning properly.

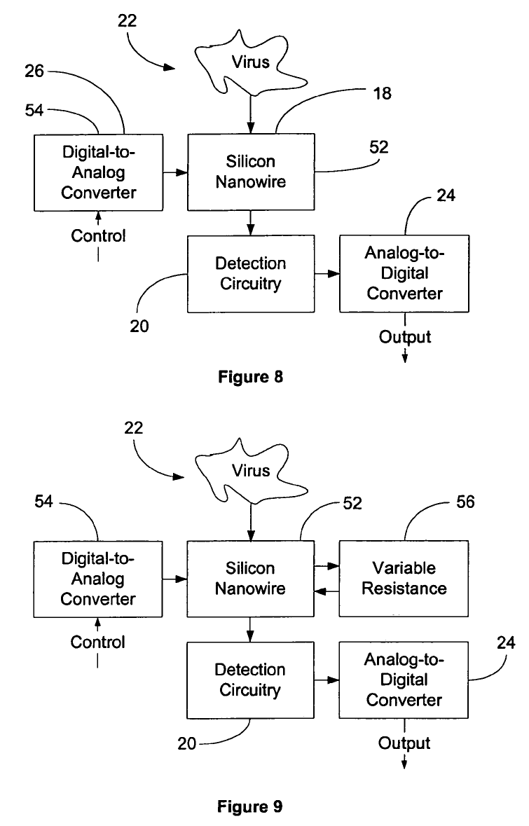

Another implementation conforming to aspects of the present invention involves a type of integrated circuit able to detect a material, with the integrated circuit including a controllable current source and/or resistance source for testing the sensors as well as the circuitry. One particular implementation illustrated in FIG. 8 involves a semiconductor with sensors in the form of a nanowire 52 or carbon nanotube mounted on the surface. Receptors are linked to the sensor surface such that conductance of the sensor changes when a target material links to the receptors on the sensors. One such nanowire sensor arrangement is described in “Electrical Detection of Single Viruses,” Patolsky et al, Publication of National Academy of Sciences (PNAS), vol. 101, no. 39, Sep. 28, 2004, which is hereby incorporated by reference herein.

Referring to the example of a silicon nanowire, for testing, a controllable current source 54 is coupled with the nanowire 52, in one example. By applying a known current to the nanowire, both the nanowire 52 and the detection circuitry 20 may be tested and/or calibrated. In one particular example, a digital-to-analog converter is employed that converts a digital control signal to a known current output. The digital-to-analog current source may also be configured to output a range of currents to the nanowire. As with other sensor implementations discussed herein, it is possible to deploy nanowire type sensors in an array, and each nanowire may be arranged to detect the same or different materials.

In another implementation illustrated in FIG. 9, a variable resistance 56 is coupled with the nanowire. The variable resistance is arranged to simulate the attachment and detachment of materials to the nanowire. By activating the resistance in the presence of a known current (from the controllable current source 54), the conductance of the nanowire effectively changes, thereby simulating the binding and unbinding of material. The conductance changes are recognized by monitoring the voltage at the nanowire output by way of the detection circuitry 20.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

I claim:

1. A bio-semiconductor integrated circuit comprising:
at least one sensor adapted to generate an output signal in the presence of a material;
detection circuitry coupled with the at least one sensor, the detection circuitry detecting a signal from the at least one sensor, the signal being a function of the presence of the material; and
a controllable signal source having a test signal output coupled with the detection circuitry, the test signal output simulating the sensor output signal.

2. The bio-semiconductor integrated circuit of claim 1 wherein the at least one sensor comprises a first electrode and a second electrode, each electrode adapted to receive a probe molecule and produce an output current when a target molecule binds with the probe molecule.

3. The bio-semiconductor integrated circuit of claim 1 wherein the controllable signal source comprises a controllable current source.

4. The bio-semiconductor integrated circuit of claim 1 wherein the at least one sensor comprises a capacitive sensor defining a capacitor that alters its dielectric constant in the presence of the material.

5. The bio-semiconductor integrated circuit of claim 1 wherein the controllable signal source comprises a controllable voltage source.

6. The bio-semiconductor integrated circuit of claim 1 wherein the at least one sensor comprises a nanowire adapted to receive a receptor and alters its conductivity when the material links with the receptor.

7. The bio-semiconductor integrated circuit of claim 1 wherein the controllable signal source comprises a controllable resistance.

8. The bio-semiconductor integrated circuit of claim 1 wherein the controllable signal source comprises means for generating the test signal.

9. The bio-semiconductor integrated circuit of claim 1 wherein the at least one sensor comprises means for detecting the presence of the material.

10. A bio-semiconductor system comprising:
a sensor site comprising:
at least one sensor adapted to generate an output signal in the presence of a material; and
detection circuitry coupled with the at least one sensor, the detection circuitry detecting a signal from the at least one sensor, the signal being a function of the presence of the material; and
a controllable signal source having a test signal output, the controllable signal source in communication with the sensor site.

11. The bio-semiconductor of claim 10 wherein the controllable signal source having a test signal is coupled with the at least one sensor.

12. The bio-semiconductor of claim 11 wherein the controllable signal source comprises a controllable current source.

13. The bio-semiconductor or claim 11 wherein the controllable signal source comprises a controllable resistance.

14. The bio-semiconductor of claim 10 wherein the at least one sensor comprises a nanowire adapted to generate a conductance change in the presence of the material.

15. A method for testing a bio-semiconductor integrated circuit, the bio-semiconductor integrated circuit including at least one sensor site adapted to generate an output signal in the presence of a material, the method comprising:
receiving a testing control signal at the bio-semiconductor integrated circuit; and
as a function of the testing control signal, generating a test signal simulating the output signal of the at least one sensor site.

16. The method of claim 15 further comprising the operation of:
detecting the test signal simulating the output signal of the at least one sensor site.

17. The method of claim 16 further comprising the operation of:
generating a second test signal as a function of the detection of the test signal simulating the output signal of the at least one sensor site.

18. The method of claim 15 wherein the operation of, as a function of the testing control signal, generating a test signal simulating the output signal of the at least one sensor site comprises generating a current simulating a current output signal of the at least one sensor site.

19. The method of claim 15 wherein the operation of, as a function of the testing control signal, generating a test signal simulating the output signal of the at least one sensor site comprises generating a voltage simulating a voltage output signal of the at least one sensor site.

20. A method for testing a bio-semiconductor integrated circuit, the bio-semiconductor integrated circuit including at least one sensor site adapted to generate an output signal in the presence of a material, the method comprising:
sending a testing control signal to the bio-semiconductor integrated circuit, the testing control signal adapted to generate a signal simulating the output signal of the at least one sensor site;
detecting a test output generated as a function of the testing control signal; and
comparing the test output with an expected output.

21. The method of claim 20 wherein the operation of sending a testing control signal to the bio-semiconductor integrated circuit, the testing control signal adapted to generate a signal simulating the output signal of the at least one sensor site, comprises sending a testing control signal to a controllable current source integrated within the bio-semiconductor integrated circuit, the testing control signal adapted to generate an output current simulating an output current signal generated from the at least one sensor site in the presence of a material.

22. The method of claim 20 wherein the operation of sending a testing control signal to the bio-semiconductor integrated circuit, the testing control signal adapted to generate a signal simulating the output signal of the at least one sensor site, comprises sending a testing control signal to a controllable voltage source integrated within the bio-semiconductor integrated circuit, the testing control signal adapted to generate an output voltage simulating an output voltage signal generated from the at least one sensor site in the presence of a material.
